(19) United States
(12) Patent Application Publication
(10) Pub. No.: US 2026/0095996 A1
(43) Pub. Date: Apr. 2, 2026

(54) LED LIGHT STRING

(71) Applicants: QINGBIAO WU, Fujian (CN); LINLIN WU, Fujian (CN)

(72) Inventors: QINGBIAO WU, Fujian (CN); LINLIN WU, Fujian (CN)

(21) Appl. No.: 18/898,697

(22) Filed: Sep. 27, 2024

(51) Int. Cl. H05B 47/135; F21S 4/10; F21V 23/00; F21V 23/06; F21Y 115/10; H05B 47/155; H05B 47/175

(52) U.S. Cl. CPC H05B 47/135; F21S 4/10; F21V 23/001; F21V 23/009; F21V 23/06; H05B 47/155; H05B 47/198; F21Y 2115/10

(57) ABSTRACT

A light string including a signal source, a main control circuit and a light string body. The light string body includes two wires, a plurality of bulb holders, and a plurality of LED bulbs. Each of the LED bulbs is provided with address information that corresponds one-to-one with each of the bulb holders, such that the bulb holders and the LED bulbs can be easily matched during assembly.

### BACKGROUND OF THE INVENTION

The present invention relates to the technical field of decorative illumination, and in particular to an LED light string.

An LED light string is composed of wires connecting LED bulbs together and is primarily used for both interior and exterior decoration, for example, it can be used to decorate Christmas trees or homes.

To improve the visual appeal of LED light strings, people have done a lot of research on the flashing control of LED light strings in recent years. A common practice is to program address codes for each LED light in a light string, allowing for individual control according to the address codes of the LED lights during control to achieve flexible lighting control effects.

Chinese Invention Patent Application No. CN112188678A discloses an LED driver chip, an LED driving method and system. The LED driver chip comprises a data signal acquisition circuit, a control circuit, and a driving circuit. The data signal acquisition circuit connects to a power signal, the data signal is modulated on the power signal in the form of a carrier signal, a data code flow is generated according to a voltage amplitude change of the power signal and a duration of the voltage amplitude change, and the data code flow includes a first address code; the control circuit receives the data code flow, calls flashing data according to the data code flow, and converts the flashing data into a control signal and outputs the control signal; the driving circuit outputs a corresponding pulse signal to an LED according to the control signal, so as to drive the LED to emit light according to preset rules. The LED driving system (LED light string) comprises a signal source, a main control circuit, an LED driver chip, and at least one LED. The signal source is used to output an initial power signal, and the main control circuit comprises a controller and a voltage adjustment circuit. The controller is configured to output a modulation instruction, the voltage adjustment circuit is connected to the signal source and the controller and is configured to correspondingly modulate a data signal on the initial power signal in the form of a carrier signal according to the modulation instruction, so as to form a power signal and output the power signal. The output end of the LED driver chip is connected to the main control circuit, and the LED is connected to the output end of the LED driver chip and is configured to correspondingly emit light based on pulse signals output by the LED driver chip according to preset rules.

In such an existing LED light string, address setting is required for the LED driver chip of each LED light in the light string to assign an address code to the LED driver chip of each LED light. During installation, the LED lights must be installed in the correct positions corresponding to the address codes so that the LED lights can be identified by the address codes and receive corresponding control signals during operation. Therefore, when assembling the LED light string, LED lights should be installed strictly according to the set positions. Once an LED light is installed in the wrong position, its address code cannot be correctly identified, and it will not receive a corresponding control signal, resulting in its inability to work normally.

To enable the LED lights to be installed in the correct positions, an existing common practice is to burn the corresponding address information into each LED light before installation. For example, in a light string with 100 LED lights numbered 1 to 100, these 100 LED lights correspond to the installation positions numbered 1 to 100 on a wire, respectively. During installation, the LED light No. 1 is first installed. The address information of the installation position No. 1 is burnt into the LED driver chip of the LED light No. 1. The LED light No. 1 is installed in the installation position No. 1 after the burning. Then, the address information of the installation position No. 2 is burnt into the LED driver chip of the LED light No. 2. The LED light No. 2 is installed in the installation position No. 2 after the burning. This process is repeated until all 100 LED lights are installed.

In the existing LED light string, to ensure strict correspondence between the address information and the installation position of each LED light in the light string, the address information is correspondingly burned into each LED light during production or just before use, and burning and installation are carried out for each LED light one at a time, resulting in lower assembly efficiency of the light string. In addition, if one or several LED lights are damaged during transportation or use, it is troublesome to replace the LED lights because of the need to spontaneously burn the address information.

### BRIEF SUMMARY OF THE INVENTION

The object of the present invention is to provide a novel LED light string that has high assembly efficiency and allows for easy replacement of LED bulbs.

To attain the above object, the present invention has the following technical solutions:
A novel LED light string, comprising a signal source, a main control circuit and a light string body which are sequentially and electrically connected; the light string body comprises two wires, a plurality of bulb holders, and a plurality of LED bulbs;
the two wires are respectively and correspondingly connected to positive and negative electrodes of an output end of the main control circuit; each of the bulb holders comprises a first power connector end and a second power connector end;
each of the first power connector ends is connected to one of the wires, and each of the second power connector ends is connected to the other wire;
each of the LED bulbs comprises a bulb housing, a control circuit disposed within the bulb housing, and at least one LED light source disposed within the bulb housing and connected to an output end of the control circuit; the bulb housing has a bulb base; the bulb base of each of the LED bulbs is correspondingly and detachably installed on each of the bulb holders; an input end of the control circuit of each of the LED bulbs connects to the output end of the main control circuit via the first power connector end and the second power connector end of the corresponding bulb holder;
the control circuit of each of the LED bulbs is provided with an LED driver chip; the LED driver chip of each of the LED bulbs stores address information that corresponds one-to-one with each of the bulb holders;
each of the LED bulbs is provided with a bulb identification symbol arranged in a certain order; each of the bulb holders is provided with a bulb holder identification symbol that corresponds one-to-one with each of the bulb identification symbols.

Furthermore, each of the bulb identification symbols is provided on each of the bulb bases.

Furthermore, each of the bulb identification symbols is fixed on each of the bulb bases by means of an adhesive.

Furthermore, each of the bulb identification symbols is integrally formed on each of the bulb bases.

Furthermore, each of the bulb identification symbols is integrally formed on an outer surface of each of the bulb bases.

Furthermore, each of the bulb holder identification symbols is fixed on each of the bulb holders by means of an adhesive.

Furthermore, each of the bulb holder identification symbols is integrally formed on each of the bulb holders.

Furthermore, each of the bulb holder identification symbols is integrally formed on an outer surface of each of the bulb holders.

Furthermore, English letters or Arabic numerals are used as the bulb identification symbols.

Furthermore, English letters or Arabic numerals are used as the bulb holder identification symbols.

In the novel LED light string of the present invention, the control circuit of each of the LED bulbs is provided with an LED driver chip; the LED driver chip of each of the LED bulbs stores address information that corresponds one-to-one with each of the bulb holders; each of the LED bulbs is provided with a bulb identification symbol arranged in a certain order; each of the bulb holders is provided with a bulb holder identification symbol that corresponds one-to-one with each of the bulb identification symbols. Before assembly, each of the LED bulbs may have all the address information stored in advance. During assembly, it is only required to match the bulb identification symbols and the bulb holder identification symbols to achieve rapid and accurate installation of the LED bulbs on the corresponding bulb holders, thereby significantly improving the assembly efficiency of the LED light string.

Moreover, the LED light string generally comes with some spare LED bulbs. If one or several LED bulbs are damaged during transportation or use, the damaged LED bulbs can be removed. The corresponding spare LED bulbs can be quickly identified through the bulb identification symbols and the damaged LED bulbs can be directly replaced by the spare LED bulbs, making replacements of the LED bulbs very convenient.

### BRIEF DESCRIPTION OF THE DRAWINGS

FIG. 1 is a schematic circuit block diagram of an LED light string according to the present invention;

FIG. 2 is a schematic circuit diagram of an LED bulb of FIG. 1;

FIG. 3 is a schematic structural diagram of an LED light string according to the present invention; and

FIG. 4 is a schematic structural diagram of a bulb housing of an LED bulb according to the present invention.

In the figures:

100: control box; 11: transformer; 11a: transformer input end; 11b: transformer output end; 111: power plug; 12: first connecting seat; 13: signal source; 131: signal source input end; 132: signal source output end; 14: main control circuit; 141: main control circuit input end; 142: main control circuit output end; 142a: positive electrode of the main control circuit output end; 142b: negative electrode of the main control circuit output end; 15: first connector; 16: second connecting seat; 200: light string body; 21: wire; 22: bulb holder; 221: bulb holder identification symbol; 222: first power connector end; 223: second power connector end; 23: LED bulb; 2300: bulb housing; 231: bulb base; 232: bulb housing body; 233: bulb identification symbol; 234: control circuit; 234a: positive electrode of the control circuit input end; 234b: negative electrode of the control circuit input end; 24: second connector; IC1: LED driver chip.

### DETAILED DESCRIPTION OF THE INVENTION

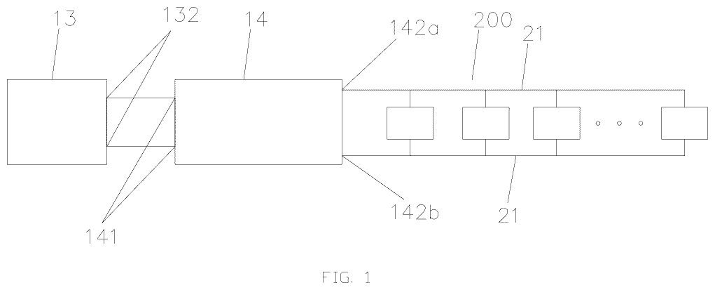

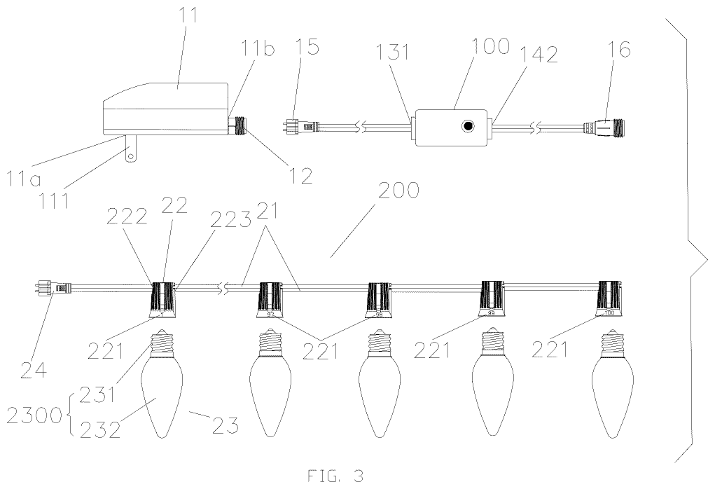

As shown in FIGS. 1 and 3, a novel LED light string of the present invention comprises a signal source 13, a main control circuit 14, and a light string body 200. An input end 131 of the signal source 13 is connected to a power supply, an output end 132 of the signal source 13 is connected to an input end 141 of the main control circuit 14, and an output end 142 of the main control circuit 14 is connected to the light string body 200.

Particularly, an input end 11a of a transformer 11 is connected to an alternating current power supply through a power plug 111, and an output end 11b of the transformer 11 is led out to a first connecting seat 12; the signal source 13 and the main control circuit 14 are installed in a control box 100, the input end 131 of the signal source 13 is led out to a first connector 15 outside the control box 100, and the first connector 15 is connected to the first connecting seat 12; the output end 142 of the main control circuit 14 is led out to a second connecting seat 16 outside the control box 100.

The light string body 200 comprises two wires 21, a plurality of bulb holders 22, and a plurality of LED bulbs 23; the two wires 21 are respectively and correspondingly connected to a positive electrode 142a and a negative electrode 142b of the output end 142 of the main control circuit 14, and each of the bulb holders 22 comprises a first power connector end 222 and a second power connector end 223. The first power connector end 222 of each of the bulb holders 22 is connected to one of the wires 21, and the second power connector end 223 of each of the bulb holders 22 is connected to the other wire 21, i.e., the bulb holders 22 are connected in parallel with each other between the two wires 21.

As a specific connection mode, one end of the two wires 21 is jointly connected to a second connector 24, and the two wires 21 are connected to the second connecting seat 16 through the second connector 24, so as to achieve a connection with the positive electrode 142a and the negative electrode 142b of the output end 142 of the main control circuit 14.

Each of the LED bulbs 23 comprises a bulb housing 2300, and a control circuit 234 and an LED light source which are both disposed within the bulb housing 2300. The bulb housing 2300 comprises a bulb base 231 and a bulb housing body 232. The bulb base 231 of each of the LED bulbs 23 is correspondingly installed on each of the bulb holders 22 and electrically connected to each of the bulb holders 22. The bulb base 231 and the bulb holder 22 are connected using a detachable connection structure, for example, the bulb base 231 and the bulb holder 22 may be connected by a conventional screw structure.

In the present invention, each of the LED bulbs 23 adopts the same control circuit 234; each of the LED bulbs 23 may contain the same or different number of LED light sources, and the number of LED light sources in each of the LED bulbs 23 generally ranges from 1 to 4. As a specific embodiment, in the present invention, each of the LED bulbs 23 contains the same number of LED light sources, with each being 4 LED light sources.

The following takes one of the LED bulbs 23 as an example for illustration.

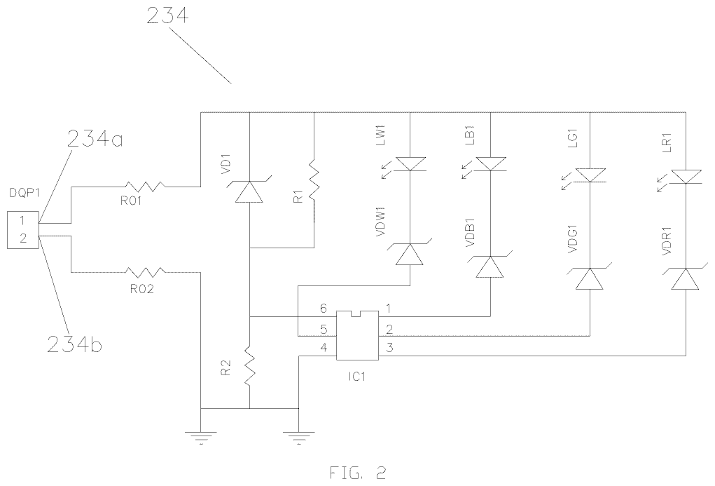

As shown in FIGS. 2 and 3, the positive electrode 234a and the negative electrode 234b of the input end of the control circuit 234 of the LED bulb 23 is connected to the first pin and the second pin of the connector DQP1 respectively, and the first pin and the second pin of the connector DQP1 are connected to the positive electrode 142a and the negative electrode 142b of the output end of the main control circuit 14 through the first power connector end 222 and the second power connector end 223 of the corresponding bulb holder 22. The control circuit 234 of the LED bulb 23 is provided with an LED driver chip IC1. The positive electrode 234a of the input end of the control circuit 234 is connected to the sixth pin of the LED driver chip IC1 through the resistor R01 and the Zener diode VD1. The sixth pin of the LED driver chip IC1 serves as the input end of the LED drive chip IC1 for power and signal, the fourth pin of the LED driver chip IC1 serves as its ground end, and the first, second, third, and fifth pins of the LED driver chip IC1 serve as its output ends (which are also the output ends of the control circuit 234). The LED light sources LW1, LB1, LG1, LR1 are connected to the first, second, third, and fifth pins of the LED driver chip IC1 through Zener diodes VDW1, VDB1, VDG1, VDR1, respectively. The LED driver chip IC1 of the LED bulb 23 stores address information that corresponds one-to-one with its installation position. Once the bulb holder 22 is installed on the wires 21, the bulb holder 22 corresponds to the installation position of the LED bulb 23.

In the present invention, well-known and commonly used technical means can be used for circuit principles of the LED light string, for example, reference may be made to the LED driving system disclosed in the Chinese invention patent application under publication no. CN112188678A. During operation, the signal source 13 is used to output an initial power signal and transmit the initial power signal to the main control circuit 14, and the main control circuit 14 modulates a data signal on the initial power signal in the form of a carrier signal, so as to form a power signal and output the power signal. The LED driver chip IC1 of each of the LED bulbs 23 in the light string body 200 is configured to receive the power signal and perform matching according to the address code. Once matched successfully, the LED driver chip IC1 of the LED bulb 23 can read various flashing data according to preset rules, and finally output a pulse signal with the corresponding duty cycle. The LED light sources connected to the output end of the LED driver chip IC1 emit light based on the pulse signal output by the LED driver chip IC1 according to the preset rules.

The main innovation points of the present invention are as follows: the LED bulbs 23 and the bulb holders 22 are respectively provided with corresponding identification symbols, so that the bulb holders 22 and the LED bulbs 23 can be quickly matched when the light string is assembled, and the assembly efficiency of the light string is improved. Additionally, when one of the LED bulbs 23 is damaged, a corresponding spare LED bulb 23 can be quickly identified.

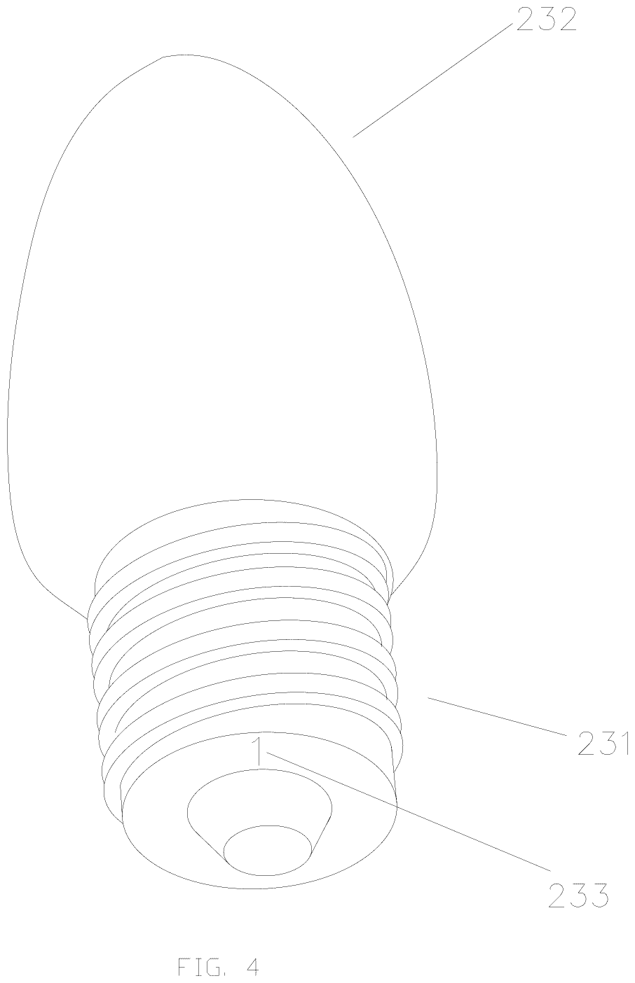

As shown in FIGS. 3 and 4, in the present invention, each of the LED bulbs 23 is provided with a bulb identification symbol 233 arranged in a certain order, and each of the bulb holders 22 is provided with a bulb holder identification symbol 221 that corresponds one-to-one with each of the the bulb identification symbols 233.

Specifically:
Each of the bulb identification symbols 233 is provided on each of the bulb bases 231.

As a preferred example, each of the bulb identification symbols 233 is integrally formed on the outer surface of the plastic member of each of the bulb bases 231 or other positions of the each of the bulb bases 231. The bulb identification symbols 233 may also be fixed respectively to the outer surfaces of the bulb bases 231 or other positions of the bulb bases 231 by means of an adhesive.

As a preferred example, each of the bulb holder identification symbols 221 may be integrally formed on the outer surface of each of the bulb holders 22 or other positions of each of the bulb holders 22. The bulb holder identification symbols 221 may also be fixed respectively to the outer surfaces of the bulb holders 22 or other positions of the bulb holders 22 by means of an adhesive.

To quickly identify and match the bulb identification symbols 233 and the bulb holder identification symbols 221, in the present invention, English letters, Arabic numerals, or characters arranged in a certain order may be used as the bulb identification symbols 233 and the bulb holder identification symbols 221.

As a preferred example, in an example of an LED light string with 100 LED bulbs, as shown in FIGS. 3 and 4, Arabic numerals in ascending order from 1 to 100 are used as the bulb identification symbol symbols 233. Correspondingly, Arabic numerals in ascending order from 1 to 100 are also used as the bulb holder identification symbols 221.

In the present invention, the bulb identification symbols 233 and the bulb holder identification symbols 221 only need to correspond to each other for easy matching, without necessarily being identical. For example, Arabic numerals in ascending order from 1 to 100 are used as the bulb identification symbols 233, and symbols with a combination of English letters and Arabic numerals in ascending order from A1 to A100 may be used for the bulb holder identification symbols 221. In addition, other numbering methods may also be used, as long as the bulb identification symbols and the bulb holder identification symbols correspond to each other and are easy to match.

Before assembling the LED light string of the present invention, the LED driver chip IC1 of each of the LED bulbs 23 may have all the address information stored in advance. During assembly, the bulb holders 22 are installed on the wires 21 in order from 1 to 100. After the bulb holders 22 are installed, the LED bulbs 23 with the corresponding bulb identification symbols 233 can be easily identified based on the bulb holder identification symbols 221, thus achieving rapid and accurate installation of the LED bulbs 23 on the corresponding bulb holders 22, and significantly improving the assembly efficiency of the LED light string.

Moreover, the LED light string generally comes with some spare LED bulbs. If one or several LED bulbs are damaged during transportation or use, the damaged LED bulbs can be removed. The corresponding spare LED bulbs can be quickly identified through the bulb identification symbols 233 and the damaged LED bulbs can be directly replaced by the spare LED bulbs, making replacements of the LED bulbs very convenient.

Furthermore, in the present invention, LED bulbs with blank address codes may also be used as spare LED bulbs. If one bulb fails, operate a bulb replacement button on the control box 100 to enter a bulb replacement mode. The bulb replacement button is connected to a corresponding input end of the main control circuit 14. Specifically, if the fifth LED bulb (the LED bulb in the installation position with the bulb holder identification symbol “5”) fails, the bulb replacement button on the control box 100 is pressed once and the first LED bulb (the LED bulb in the installation position with the bulb holder identification symbol “1”) lights up, and then the bulb replacement button is pressed again and the second LED bulb (the LED bulb in the installation position with the bulb holder identification symbol “2”) lights up. In this way, each time the bulb replacement button is pressed, the LED bulb in the next installation position will light up. When the bulb replacement button is pressed the fifth time, the LED bulb in the fifth installation position cannot light up due to its failure, and the LED bulb is removed and replaced with the LED bulb with a blank address code. Then, operate a burn-in button on the control box 100. The burn-in button is connected to a corresponding input end of the main control circuit 14. An IC of the main control circuit 14 will give a burn-in signal to the LED bulb with a blank address code, burning in an address code corresponding to the current installation position to the LED bulb with a blank address code, thereby completing the replacement of the LED bulb.

Although the embodiments of the present invention have been illustrated and described, it should be understood that changes, modifications, substitutions, and alterations can be made to such embodiments by those of ordinary skill in the art without departing from the principle and spirit of the present invention, and the scope of the present invention is limited by the appended claims and equivalents thereof.

1. A LED light string, comprising:
a signal source;
a main control circuit with an output end having positive and negative electrodes;
a light string body comprising:
two wires each connected to a respective one of the positive and negative electrodes of the main control circuit,
a plurality of bulb holders each including first and second power connectors, the power connectors connected to a respective one of the wires, and
a plurality of LED bulbs each including a bulb housing with a bulb base detachably installed in each of the bulb holders, a control circuit disposed within the bulb housing with an input end connected to the output end of the main control circuit via the first and second connectors, an LED driver chip provided in the control circuit for storing address information that corresponds one-to-one with each of the bulb holders, and at least one LED light source disposed within the bulb housing
a bulb identification symbol provided in each of the LED bulbs; and
a bulb holder identification symbol provided in each of the bulb holders, each bulb holder identification symbol corresponding one-to-one with each of the bulb identification symbols.

2. The LED light string of claim 1, wherein each of the bulb identification symbols is provided on each of the bulb bases.

3. The LED light string of claim 2, wherein each of the bulb identification symbols is fixed on each of the bulb bases by means of an adhesive.

4. The LED light string of claim 2, wherein each of the bulb identification symbols is integrally formed on each of the bulb bases.

5. The LED light string of claim 4, wherein each of the bulb identification symbols is integrally formed on an outer surface of each of the bulb bases.

6. The LED light string of claim 1, wherein each of the bulb holder identification symbols is fixed on each of the bulb holders by means of an adhesive.

7. The LED light string of claim 1, wherein each of the bulb holder identification symbols is integrally formed on each of the bulb holders.

8. The LED light string of claim 7, wherein each of the bulb holder identification symbols is integrally formed on an outer surface of each of the bulb holders.

9. The novel-LED light string of claim 1, wherein English letters or Arabic numerals are used as the bulb identification symbols.

10. The novel LED light string of claim 1, wherein English letters or Arabic numerals are used as the bulb holder identification symbols.
